(19) United States
(12) Patent Application Publication
(10) Pub. No.: US 2021/0125478 A1
(43) Pub. Date: Apr. 29, 2021

(54) INTELLIGENT SECURITY DEVICE

(71) Applicant: LG ELECTRONICS INC., Seoul (KR)

(72) Inventors: Heesoo KIM, Seoul (KR); Changho CHOI, Seoul (KR)

(73) Assignee: LG ELECTRONICS INC., Seoul (KR)

(21) Appl. No.: 16/996,353

(22) Filed: Aug. 18, 2020

(30) Foreign Application Priority Data
Oct. 29, 2019 (KR) 10-2019-0135471

(51) Int. Cl. G08B 21/02; G08B 21/22; G06N 3/04; G06N 3/08

(52) U.S. Cl. CPC G08B 21/02; G06N 3/08; G06N 3/04; G08B 21/22

(57) ABSTRACT

An intelligent security device can include a camera; a transceiver configured to communicate with a cloud or an external device; and a controller configured to acquire motion information of a pedestrian based on a video captured by the camera, transmit, via the transceiver, the motion information or the video to the cloud or the external device, execute a warning function when a behavior of the pedestrian is determined to correspond to a potential criminal behavior, and execute a guiding function when the behavior of the pedestrian is determined to correspond to a wandering behavior.

### CROSS REFERENCE TO RELATED APPLICATIONS

This Application claims the benefit of Korean Patent Application No. 10-2019-0135471, filed in the Republic of Korea on Oct. 29, 2019, which is incorporated herein by reference for all purposes as if fully set forth herein.

### BACKGROUND OF THE INVENTION

### Field of the Invention

The present disclosure relates to an intelligent security device.

### Discussion of the Related Art

Recently, crimes targeting young children, students, women, etc. are increasing, and these various crimes are causing a big wave as social and national problems.

In the related art, in order to prevent such crimes, a method for preventing and monitoring crimes was provided by increasing security agents or installing surveillance cameras in a jurisdiction. The surveillance camera is constructed as a system that sends a captured video of an installed place to a remote control server, displays the captured video on the control server, and records the captured video per time zone or in real time. Alternatively, the surveillance camera is constructed as a system in which administrator seeks for an immediate response to the crime while he or she monitors a captured video of the surveillance camera in real time. However, such systems have a problem that it is difficult to immediately recognize a crisis and immediately protect a victim from the crime. In particular, the immediate response is often impossible because of fear of retaliation due to the victim's direct report, or contact disruption of an abuser, etc.

Further, if a video of a CCTV is analyzed as a follow-up measure, there is a problem with blind spots that occur due to a limited range of the CCTV.

### SUMMARY OF THE INVENTION

An object of the present disclosure is to address the above-described and other needs and/or problems.

Another object of the present disclosure is to provide an intelligent security device capable of providing smart cities, disaster information and safety information, etc. by providing voice information and video information on a CCTV and a type that adds a video projection function and is able to maximize security enhancement and convenience function, e.g., a crime prevention function using the video projection function.

In one aspect, there is provided an intelligent security device comprising a camera; a processor configured to acquire motion information of a pedestrian based on a video taken with the camera; and a transceiver configured to transmit the motion information to a cloud and receive, from the cloud, a command that is able to be executed by the processor, in which the command includes a first command that recognizes field status information based on the motion information, outputs a warning signal if a behavior of the pedestrian in the recognized field status information is determined as a potential crime behavior, and controls the processor in response to the warning signal; and a second command that recognizes the field status information based on the motion information, outputs a guide signal if the behavior of the pedestrian in the recognized field status information is determined as a wandering behavior, and controls the processor in response to the guide signal.

The processor may be configured to extract features values from the motion information acquired by the camera, and input the features values to an artificial neural network (ANN) classifier, that is trained to distinguish whether the pedestrian is in an everyday behavior state or a criminal behavior state, and determine whether the behavior of the pedestrian is in the criminal behavior state based on an output of the ANN classifier. The features values may be values capable of determining whether the behavior of the pedestrian is in a normal state or an abnormal state.

The processor may be configured to extract features values from the motion information acquired by the camera, and input the features values to an artificial neural network (ANN) classifier, that is trained to distinguish whether the pedestrian is in an everyday behavior state or a wandering behavior state, and determine whether the behavior of the pedestrian is in the wandering behavior state based on an output of the ANN classifier. The features values may be values capable of determining whether the behavior of the pedestrian is in an everyday state or a wandering state.

The motion information may include at least one of a behavior of the pedestrian, a walking speed of the pedestrian, a walking path of the pedestrian, or a walk of the pedestrian.

The processor may be configured to receive, from a network, downlink control information (DCI) that is used to schedule a transmission of the motion information acquired by the camera. The motion information may be transmitted to the network based on the DCI.

The processor may perform an initial access procedure with the network based on a synchronization signal block (SSB). The motion information may be transmitted to the network via a physical uplink shared channel (PUSCH). The SSB and a DM-RS of the PUSCH may be QCLed for QCL type D.

The processor may be configured to control the transceiver to transmit the motion information to an artificial intelligence (AI) processor included in the network, control the transceiver to receive AI-processed information from the AI processor. The AI-processed information may be information that determines the behavior of the pedestrian as one of a normal state and an abnormal state.

Effects of an intelligent security device according to embodiments of the present disclosure are described as follows.

The present disclosure can provide smart cities, disaster information and safety information, etc. by providing voice information and video information on a CCTV and a type that adds a video projection function and is able to maximize security enhancement and convenience function, e.g., a crime prevention function using the video projection function.

Effects obtainable from the present disclosure are not limited by the effects mentioned above, and other effects which are not mentioned above can be clearly understood from the following description by those skilled in the art to which the present disclosure pertains.

### BRIEF DESCRIPTION OF THE DRAWINGS

The accompanying drawings, that may be included to provide a further understanding of the disclosure and are incorporated in and constitute a part of the disclosure, illustrate embodiments of the disclosure and together with the description serve to explain various principles of the disclosure.

FIG. 1 is a block diagram of a wireless communication system to which methods proposed in the disclosure are applicable according to an embodiment of the present disclosure.

FIG. 2 shows an example of a signal transmission/reception method in a wireless communication system according to an embodiment of the present disclosure.

FIG. 3 shows an example of basic operations of a user equipment and a 5G network in a 5G communication system according to an embodiment of the present disclosure.

FIG. 4 illustrates an intelligent security device according to an embodiment of the present disclosure.

FIG. 5 is a block diagram of an AI device according to an embodiment of the present disclosure.

FIG. 6 illustrates an example of an artificial neural network model according to an embodiment of the present disclosure.

FIG. 7 illustrates a system in which a server is associated with an intelligent security device according to an embodiment of the present disclosure.

FIG. 8 is a flow chart of a method of controlling an intelligent security device according to an embodiment of the present disclosure.

FIG. 9 illustrates an example of determining a potential criminal state if a first command is sent in accordance with an embodiment of the present disclosure.

FIG. 10 illustrates another example of determining a potential criminal state if a first command is sent in accordance with an embodiment of the present disclosure.

FIG. 11 illustrates an example of determining a potential criminal state if a second command is sent in accordance with an embodiment of the present disclosure.

FIG. 12 illustrates another example of determining a potential criminal state if a second command is sent in accordance with an embodiment of the present disclosure.

FIG. 13 illustrates an example of determining a potential criminal state using an intelligent security device according to an embodiment of the present disclosure.

FIG. 14 illustrates an example of determining a potential user using an intelligent security device according to an embodiment of the present disclosure.

### DETAILED DESCRIPTION OF THE EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first,” “second,” etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the disclosure, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

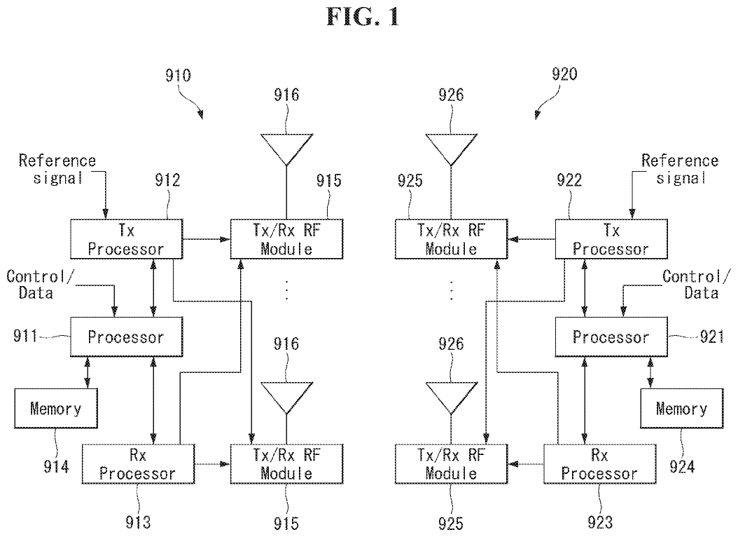

FIG. 1 is a block diagram of a wireless communication system to which methods proposed in the disclosure are applicable.

Referring to FIG. 1, a device (AI device) including an AI module is defined as a first communication device (910 of FIG. 1), and a processor 911 can perform detailed AI operation.

A 5G network including another device (AI server) communicating with the AI device is defined as a second communication device (920 of FIG. 1), and a processor 921 can perform detailed AI operations.

The 5G network may be represented as the first communication device and the AI device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (e.g., physical layer) in DL (communication from the first communication device to the second communication device). The Rx processor implements various signal processing functions of L1 (e.g., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

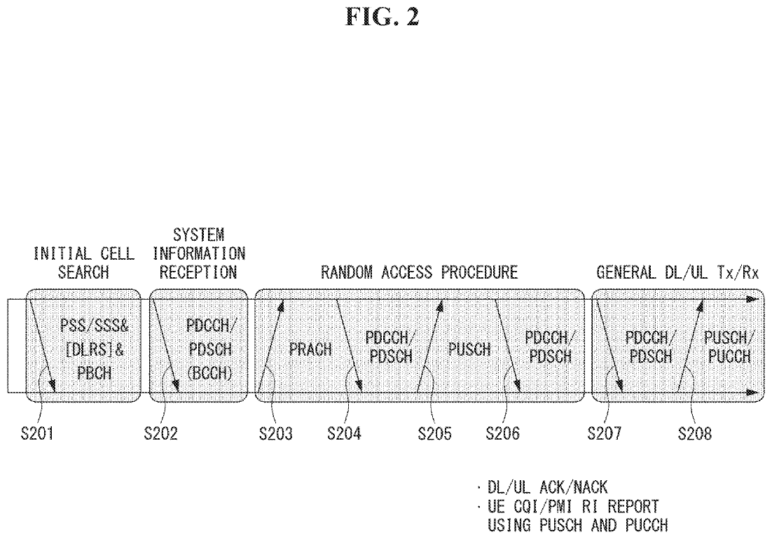

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission based on DCI in the detected PDCCH. The PDCCH can be used to schedule DL transmissions over a PDSCH and UL transmissions over a PUSCH. Here, the DCI in the PDCCH includes downlink assignment (e.g., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement based on an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (e.g., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission based on most recent pathloss and a power ramping counter.

The UE can perform UL transmission through Msg3 of the random access procedure over a physical uplink shared channel based on the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS based on the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted based on SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequency Sect.

The UE receives DCI format 2_1 from the BS based on the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data based on signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation of AI Processing Using 5G Communication

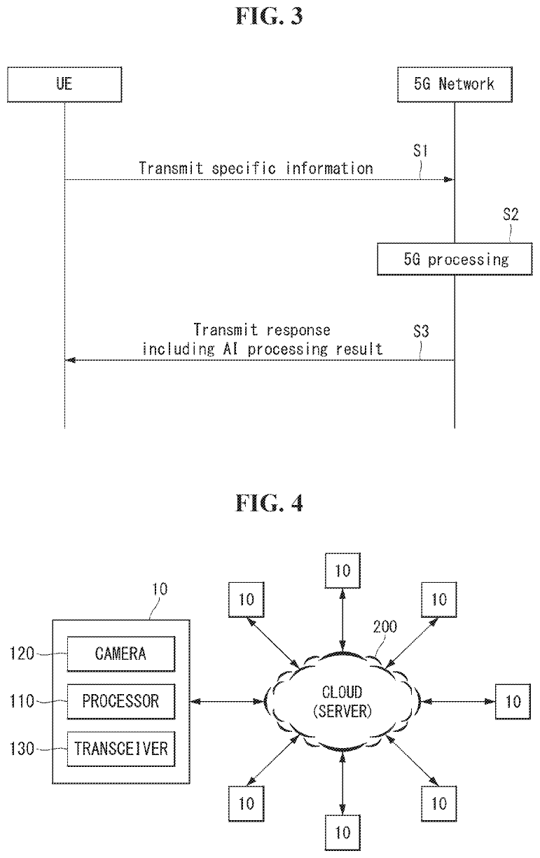

FIG. 3 shows an example of basic operations of AI processing in a 5G communication system.

The UE transmits specific information to the 5G network (S1). The 5G network may perform 5G processing related to the specific information (S2). Here, the 5G processing may include AI processing. And the 5G network may transmit response including AI processing result to UE (S3).

G. Applied Operations Between UE and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network based on an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network based on the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control based on the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network based on DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted based on the information on the number of repetitions. That is, the autonomous vehicle transmits the specific information to the 5G network based on the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present disclosure which will be described later and applied or can complement the methods proposed in the present disclosure to make technical features of the methods concrete and clear.

FIG. 4 illustrates an intelligent security device according to an embodiment of the present disclosure.

Referring to FIG. 4, an intelligent security device 10 according to an embodiment of the present disclosure may be electrically connected to a cloud 200 and transmit or receive information to or from the cloud 200.

The intelligent security device 10 may include a processor 110, a camera 120, and a transceiver 130.

The camera 120 may be mounted on a body of the intelligent security device 10. At least one camera 120 may be mounted on the body of the intelligent security device 10. The camera 120 may capture a predetermined range or area. The plurality of cameras 120 may be mounted toward different directions to capture different ranges or areas. Alternatively, the plurality of cameras 120 may have different functions. For example, the camera 120 may include a plurality of closed circuit television (CCTV) cameras, a plurality of infrared thermal sensor cameras, and the like.

One of the plurality of cameras 120 disposed in the substantially same direction may zoom in an object and capture a small area. Another camera of the plurality of cameras 120 may zoom out an object and capture a large area.

The camera 120 may provide a video taken in real time to the processor 110 or a memory to be described below.

The processor 110 may acquire motion information based on the video taken by the camera 120. The processor 110 may be electrically connected to the camera 120, the transceiver 130, the memory to be described below, and a power supply unit and may exchange signals with them. The processor 110 may be implemented using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, or electrical units for performing other functions.

The processor 110 may be driven by power provided by the power supply unit to be described below. The processor 110 may receive and process data, generate signals, and provide the signals in a state where power is provided by the power supply unit.

The transceiver 130 may transmit the captured video and the motion information to the cloud 200 and receive, from the cloud 200, a command that can be executed by the processor 110. The transceiver 130 may exchange signals with the cloud 200 located outside the intelligent security device 10 or another intelligent security device 10.

For example, the transceiver 130 may exchange signals with at least one of an infrastructure (e.g., server, cloud), another intelligent security device 10, or a terminal. The transceiver 130 may include at least one of a transmission antenna, a reception antenna, a radio frequency (RF) circuit capable of implementing various communication protocols, and a RF element, in order to perform communication.

The cloud 200 may store the captured video and the motion information received from the transceiver 130 in a main processor connected to a 5G network. The main processor may learn a neural network for recognizing data related to whether there is a potential crime or a potential user based on the motion information. Here, the neural network for recognizing data related to whether there is a potential crime or a potential user may be designed to emulate a human brain structure on a computer and may include a plurality of network nodes with weight that emulates neurons of a human neural network. The plurality of network nodes may transmit and receive data according to each connection relationship so that neurons emulate the synaptic activity of neurons sending and receiving signals through synapses. Here, the neural network may include a deep learning model which has evolved from a neural network model. In the deep learning model, the plurality of network nodes may be arranged in different layers and may transmit and receive data according to a convolution connection relationship. Examples of the neural network model may include various deep learning techniques, such as deep neural networks (DNN), convolutional deep neural networks (CNN), recurrent Boltzmann machine (RNN), restricted Boltzmann machine (RBM), deep belief networks (DBN), and deep Q-networks, and are applicable to fields including computer vision, voice recognition, natural language processing, and voice/signal processing, etc.

The main processor performing the above-described functions may be a general purpose processor (e.g., CPU), but may be an AI processor (e.g., GPU) for AI learning.

Hence, the plurality of intelligent security devices 10 may transmit the captured video and the motion information to the cloud 200 over the 5G network and receive, from the cloud 200, a command that can be executed by the processor 110. The cloud 200 may be called a server.

The command that the cloud 200 transmits to the intelligent security device 10 may include a first command and a second command.

The first command may be a command capable of determining whether there is a potential crime based on the motion information transmitted to the cloud 200.

The second command may be a command capable of determining whether there is a potential user based on the motion information.

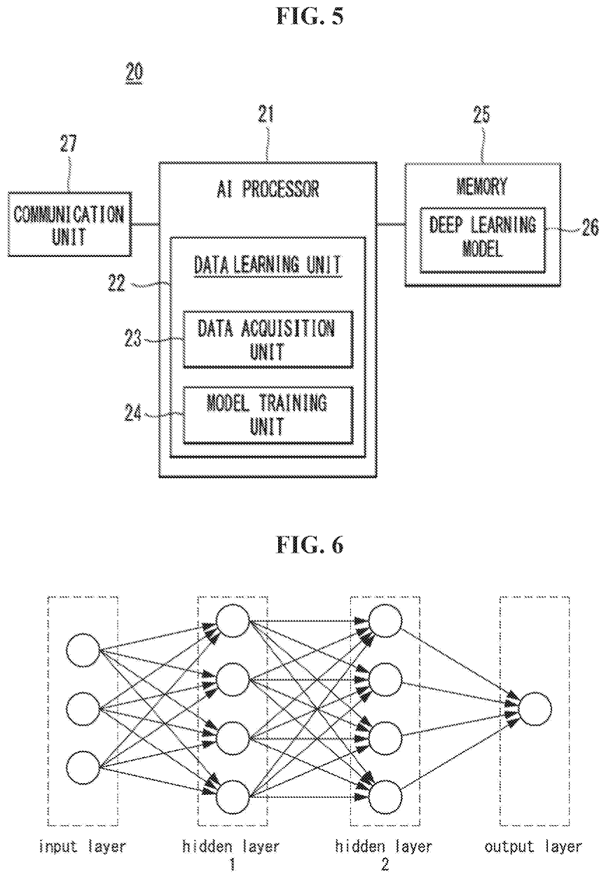

FIG. 5 is a block diagram of an AI device according to an embodiment of the present disclosure.

The AI device 20 may include electronic equipment that includes an AI module to perform AI processing or a server that includes the AI module. Furthermore, the AI device 20 may be included in at least a portion of the intelligent security device 10, and may be provided to perform at least some of the AI processing.

The AI processing may include all operations related to the function of the intelligent security device 10. For example, the mobile terminal may AI-process sensing data or travel data to perform processing/determining and a control-signal generating operation. Furthermore, for example, the mobile terminal may AI-process data acquired through interaction with other electronic equipment provided in the mobile terminal to control sensing.

The AI device 20 may include an AI processor 21, a memory 25 and/or a communication unit 27.

The AI device 20 may be a computing device capable of learning a neural network, and may be implemented as various electronic devices such as a server, a desktop PC, a laptop PC or a tablet PC.

The AI processor 21 may learn the neural network using a program stored in the memory 25. Particularly, the AI processor 21 may learn the neural network for recognizing data related to the intelligent security device 10. Here, the neural network for recognizing data related to the intelligent security device 10 may be designed to simulate a human brain structure on the computer, and may include a plurality of network nodes having weights that simulate the neurons of the human neural network. The plurality of network nodes may exchange data according to the connecting relationship to simulate the synaptic action of neurons in which the neurons exchange signals through synapses. Here, the neural network may include the deep learning model developed from the neural network model. While the plurality of network nodes is located at different layers in the deep learning model, the nodes may exchange data according to the convolution connecting relationship. Examples of the neural network model include various deep learning techniques, such as a deep neural network (DNN), a convolution neural network (CNN), a recurrent neural network (RNN, Recurrent Boltzmann Machine), a restricted Boltzmann machine (RBM,), a deep belief network (DBN) or a deep Q-Network, and may be applied to fields such as computer vision, voice recognition, natural language processing, voice/signal processing or the like.

Meanwhile, the processor performing the above-described function may be a general-purpose processor (e.g. CPU), but may be an AI dedicated processor (e.g. GPU) for artificial intelligence learning.

The memory 25 may store various programs and data required to operate the AI device 20. The memory 25 may be implemented as a non-volatile memory, a volatile memory, a flash memory), a hard disk drive (HDD) or a solid state drive (SDD). The memory 25 may be accessed by the AI processor 21, and reading/writing/correcting/deleting/update of data by the AI processor 21 may be performed.

Furthermore, the memory 25 may store the neural network model (e.g. the deep learning model 26) generated through a learning algorithm for classifying/recognizing data in accordance with the embodiment of the present disclosure.

The AI processor 21 may include a data learning unit 22 which learns the neural network for data classification/recognition. The data learning unit 22 may learn a criterion about what learning data is used to determine the data classification/recognition and about how to classify and recognize data using the learning data. The data learning unit 22 may learn the deep learning model by acquiring the learning data that is used for learning and applying the acquired learning data to the deep learning model.

The data learning unit 22 may be made in the form of at least one hardware chip and may be mounted on the AI device 20. For example, the data learning unit 22 may be made in the form of a dedicated hardware chip for the artificial intelligence AI, and may be made as a portion of the general-purpose processor (CPU) or the graphic dedicated processor (GPU) to be mounted on the AI device 20. Furthermore, the data learning unit 22 may be implemented as a software module. When the data learning unit is implemented as the software module (or a program module including instructions), the software module may be stored in a non-transitory computer readable medium. In this case, at least one software module may be provided by an operating system (OS) or an application.

The data learning unit 22 may include the learning-data acquisition unit 23 and the model learning unit 24.

The learning-data acquisition unit 23 may acquire the learning data needed for the neural network model for classifying and recognizing the data. For example, the learning-data acquisition unit 23 may acquire vehicle data and/or sample data which are to be inputted into the neural network model, as the learning data.

The model learning unit 24 may learn to have a determination criterion about how the neural network model classifies predetermined data, using the acquired learning data. The model learning unit 24 may learn the neural network model, through supervised learning using at least some of the learning data as the determination criterion. Alternatively, the model learning unit 24 may learn the neural network model through unsupervised learning that finds the determination criterion, by learning by itself using the learning data without supervision. Furthermore, the model learning unit 24 may learn the neural network model through reinforcement learning using feedback on whether the result of situation determination according to the learning is correct. Furthermore, the model learning unit 24 may learn the neural network model using the learning algorithm including error back-propagation or gradient descent.

If the neural network model is learned, the model learning unit 24 may store the learned neural network model in the memory. The model learning unit 24 may store the learned neural network model in the memory of the server connected to the AI device 20 with a wire or wireless network.

The data learning unit 22 may further include a learning-data preprocessing unit and a learning-data selection unit to improve the analysis result of the recognition model or to save resources or time required for generating the recognition model.

The learning-data preprocessing unit may preprocess the acquired data so that the acquired data may be used for learning for situation determination. For example, the learning-data preprocessing unit may process the acquired data in a preset format so that the model learning unit 24 may use the acquired learning data for learning for image recognition.

Furthermore, the learning-data selection unit may select the data required for learning among the learning data acquired by the learning-data acquisition unit 23 or the learning data preprocessed in the preprocessing unit. The selected learning data may be provided to the model learning unit 24. For example, the learning-data selection unit may select only data on the object included in a specific region as the learning data, by detecting the specific region in the image acquired by the camera of the intelligent security device 10.

Furthermore, the data learning unit 22 may further include a model evaluation unit to improve the analysis result of the neural network model.

When the model evaluation unit inputs evaluated data into the neural network model and the analysis result outputted from the evaluated data does not satisfy a predetermined criterion, the model learning unit 22 may learn again. In this case, the evaluated data may be predefined data for evaluating the recognition model. By way of example, the model evaluation unit may evaluate that the predetermined criterion is not satisfied when the number or ratio of the evaluated data in which the analysis result is inaccurate among the analysis result of the learned recognition model for the evaluated data exceeds a preset threshold.

The communication unit 27 may transmit the AI processing result by the AI processor 21 to the external electronic equipment.

Here, the external electronic equipment may be defined as the intelligent security device 10. Furthermore, the AI device 20 may be defined as another intelligent security device 10 or a 5G network that communicates with the intelligent security device 10. Meanwhile, the AI device 20 may be implemented by being functionally embedded in an autonomous driving module provided in the intelligent security device 10. Furthermore, the 5G network may include a server or a module that performs related control of the intelligent security device 10.

Although the AI device 20 illustrated in FIG. 5 is functionally divided into the AI processor 21, the memory 25, the communication unit 27 and the like, it is to be noted that the above-described components are integrated into one module, which is referred to as an AI module.

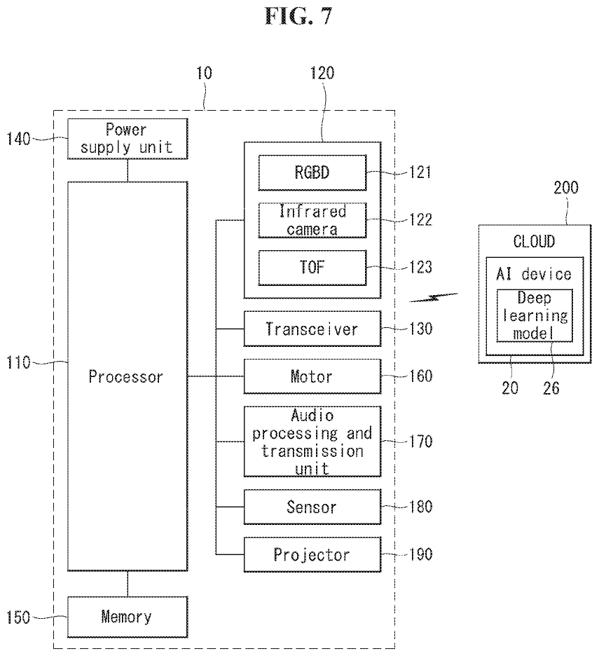

FIG. 6 is a diagram illustrating a deep neural network structure for a notification providing method proposed in the present disclosure.

Referring to FIG. 6, the DNN is an artificial neural network (ANN) configured with several hidden layers between an input layer and an output layer. The DNN may model complex non-linear relationships, as in a general artificial neural network.

For example, in a deep neural network structure for an object identification model, each object may be represented with a hierarchical configuration of basic elements of an image. In this case, the additional layers may combine characteristics of gradually gathered lower layers. Such a characteristic of the deep neural network may model complex data with only fewer units (nodes), compared with a similarly performed artificial neural network.

As the number of hidden layers increases, the artificial neural network is called ‘deep’, and the machine learning paradigm that uses this deeply deep artificial neural network as a learning model is called Deep Learning. In addition, a sufficiently deep artificial neural network used for deep learning is commonly referred to as a deep neural network (DNN).

In the present disclosure, data required to train an optical character recognition (OCR) model may be input to an input layer of a DNN, as they go through the hidden layers, meaningful data that can be used by the user can be generated through the output layer.

In this disclosure, the artificial neural network used for such a deep learning method is commonly referred to as DNN, but if it is possible to output meaningful data in a similar manner, other deep learning methods or machine learning methods may be applied.

FIG. 7 illustrates a system in which a server is associated with an intelligent security device according to an embodiment of the present disclosure.

Referring to FIG. 7, an intelligent security device 10 may transmit data requiring AI processing to a server 200 through a transceiver 130, and the server 200 may include an AI device 20. The AI device 20 including a deep learning model 26 may transmit a result of AI processing using the deep learning model 26 to the intelligent security device 10. The server 200 may refer to the description described above with reference to FIG. 4, and the AI device 20 included in the server 200 may refer to the description described above with reference to FIG. 5.

The intelligent security device 10 may include a memory 150, a processor 110, and a power supply unit 140. The intelligent security device 10 may further include an interface that is wiredly or wirelessly connected to at least one electronic device included in the intelligent security device 10 and can exchange data necessary for the control of the intelligent security device 10. At least one electronic device connected via the interface may include the transceiver 130, a motor 160, an audio processing and transmission unit 170, a sensor 180, a projector 190, and a camera 120.

The interface may consist of at least one of a communication module, a terminal, a pin, a cable, a port, a circuit, an element, and a device.

The memory 150 may be electrically connected to the processor 110. The memory 150 may store basic data for a unit, control data for operation control of the unit, and input/output data. The memory 150 may store data processed in the processor 110. The memory 150 may consist of at least one of a ROM, RAM, EPROM, flash drive, or hard drive in hardware. The memory 150 may store a variety of data for overall operation of the intelligent security device 10, such as a program for the processing or control of the processor 110. The memory 150 may be integrally implemented with the processor 110. In some embodiments, the memory 150 may be classified into a sub-component of the processor 110.

The power supply unit 140 may supply power to the intelligent security device 10. The power supply unit 140 may receive power from a power source (e.g., battery) included in the intelligent security device 10 or receive power from the outside to supply the power to each unit of the intelligent security device 10. The power supply unit 140 may operate in response to a control signal provided by the processor 110. The power supply unit 140 may include a switched-mode power supply (SMPS).

The processor 110 may be electrically connected to the memory 150, the interface, and the power supply unit 140 and may exchange signals with them. The processor 110 may be implemented using at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, or electrical units for performing other functions.

The processor 110 may be driven by the power provided by the power supply unit 140. The processor 110 may receive and process data, generate a signal, and provide the signal in a state where the power is provided by the power supply unit 140.

The processor 110 may receive information from another electronic device included in the intelligent security device 10 via the interface. The processor 110 may provide a control signal to another electronic device included in the intelligent security device 10 via the interface.

The intelligent security device 10 may include at least one printed circuit board (PCB). The printed circuit board may be electrically connected to the memory 150, the interface, the power supply unit 140, and the processor 110.

Other electronic devices inside the intelligent security device 10 connected to the interface are described in detail below.

The transceiver 130 may transmit a captured video and motion information to the server 200 and receive, from the server 200, a command that can be executed by the processor 110. The transceiver 130 may exchange signals with the server 200 located outside the intelligent security device 10 or another device. The server 200 may be called a cloud 200.

For example, the transceiver 130 may exchange signals with at least one of an infrastructure (e.g., server, cloud), another intelligent security device 10, or a terminal. The transceiver 130 may include at least one of a transmission antenna, a reception antenna, a radio frequency (RF) circuit capable of implementing various communication protocols, and a RF element, in order to perform communication.

The motor 160 may control the camera 120 under the control of the processor 110. The motor 160 may be physically connected to the camera 120 and drive the camera 120 so that the camera 120 moves in various directions. The motor 160 may operate to rotate 360 degrees under the control of the processor 110. The motor 160 may include a servo motor. The servo motor may be an electric motor that is used to convert a voltage input in an automatic control structure or an automatic balancing instrument into a mechanical motion and adjust a rotation angle. Examples of the servo motor may include 2-phase AC servo motor and DC servo motor. In particular, a small-sized servo motor may be called a micromotor. The servo motor may include an encoder and a feedback device that can accurately count the number of rotations. The servo motor may perform an accurate location control by operating the encoder and the feedback device under the control of the processor 110.

The audio processing and transmission unit 170 may collect an audio signal generated in a video taken with the camera 120 and output a notification sound transmitted from the cloud 200. For example, the audio signal may include sound or voice, etc. The audio processing and transmission unit 170 may include a microphone 171 capable of collecting the audio signal generated in the video taken with the camera 120 and a speaker 172 capable of outputting the notification sound to the outside.

The audio processing and transmission unit 170 may transmit, to the cloud 200, the video input from the camera 120 or the audio signal input to the microphone 171 over Wi-Fi or 5G network. The cloud 200 may determine whether there is a potential crime or a potential user by analyzing the audio signal over an artificial neural network installed in a main processor and may send a determined command to the transceiver 130 over Wi-Fi or 5G network. The audio processing and transmission unit 170 may send the notification sound to the outside under the control of the processor 110.

The sensor 180 may include at least one of a motion sensor, an ultrasonic sensor, and an infrared sensor. The sensor 180 may provide the cloud 200 with data for a motion generated based on a sensing signal, which is generated by a motion generated in an area taken by the camera 120, through the processor 110 or the transceiver 130. The motion generated in the area taken by the camera 120 may include person and may be defined as a movement of an animal.

For example, if the sensing signal is transmitted from the sensor 180 sensing a specific area or a corresponding area, the processor 110 may control the motor 160 to control the direction of the camera 120 so that the camera 120 captures the specific area or the corresponding area.

The projector 190 may be mounted on the intelligent security device 10 and receive a notification video provided by the cloud 200 through the transceiver 190 to project or display the notification video on a partial area. The projector 190 may receive the notification video from the cloud 200 and project or display the notification video, that is enlarged through a lens, on a partial area. The projector 190 may project or display the video in various ways. Examples of the projector 190 may include a CRT projector that combines and displays light coming from three CRTs (green, red and blue) in a CRT manner like TVs, a LCD projector that displays combined pixels of three colors on the screen in a liquid crystal manner, and a DLP projector that uses a digital light processing technology.

The projector 190 may send the notification video and the notification sound to the outside together with the audio processing and transmission unit 170 under the control of the processor 110.

The camera 120 may be mounted on the intelligent security device 10 and may capture a predetermined area or a specific area. The predetermined area or the specific area may be captured by the plurality of cameras 120. The camera 120 may include a RGBD (Red, Green, Blue, Distance) camera 121, an infrared camera 122, and a time-of-flight (ToF) camera 123.

The RGBD camera 121 may detect a motion in the predetermined area or the specific area using captured images having depth data obtained from the camera 120 having RGBD sensors or other similar 3D imaging devices.

The infrared camera 122 may be a charge coupled device (CCD) camera with a sufficient intensity for infrared light. For example, if the infrared camera 122 captures a pedestrian in a predetermined area or a specific area at night, the infrared camera 122 may relatively accurately recognize the pedestrian in the predetermined area or the specific area by attaching an infrared filter to the lighting with strong light collection. For example, if the infrared camera 122 captures wildlife at night, the infrared camera 122 does not destroy the natural ecosystem by attaching an infrared filter to the lighting with strong light collection, and thus may be very effective.

The ToF camera 123 may use a method of calculating a distance based on a time difference between the emission of light and its return after being reflected. That is, the ToF camera 123 may be a camera that outputs a distance image using a ToF method.

As described above, the camera 120 may include cameras with different manners. The processor 120 may acquire motion information in a video taken with at least one camera 120 embedded in the intelligent security device 10. The motion information may be information or data about behavior of a pedestrian moving in a predetermined area or a specific area.

The intelligent security device 10 may transmit, to the cloud 200, a video taken by the camera 120 and motion information through the transceiver 130. The cloud 200 may include the AI device 20. The AI device 20 may transmit AI-processed data to the intelligent security device 10 by applying a neural network model to the received video and motion information.

FIG. 8 is a flow chart of a method of controlling an intelligent security device according to an embodiment of the present disclosure.

A method of controlling an intelligent security device according to an embodiment of the present disclosure may be implemented in an intelligent security device having functions described with reference to FIGS. 1 to 7 or a cloud controlling the intelligent security device. More specifically, a method of controlling an intelligent security device according to an embodiment of the present disclosure may be may be implemented in the intelligent security device 10 described with reference to FIGS. 4 to 7.

A processor may acquire motion information based on a video taken by a camera in S710. The processor may acquire motion information through at least one camera embedded in an intelligent security device.

The camera may be disposed to capture a predetermined area or a specific area. The processor may acquire motion information based on a pedestrian's behavior, a pedestrian's speed, a pedestrian's path, a pedestrian's walking, etc. in the video taken by the camera. The processor may also include, in the motion information, information about a pedestrian's face, a pedestrian's expression, things a pedestrian is holding, a pedestrian's skin color, a pedestrian's attire, etc. using sensors.

A transceiver may transmit, to a cloud, a video taken by the camera and motion information under the control of the processor. The cloud may analyze the video and the motion information and determine whether there is a potential crime or a potential user in the predetermined area or the specific area based on them in S720. For example, the cloud may distinguish and determine whether there is the potential crime or the potential user using an artificial neural network that is trained to distinguish whether there is the potential crime or the potential user. The cloud may extract a feature value of the pedestrian from the motion information over the artificial neural network programmed in a main processor. For example, the cloud may program one of histogram of oriented gradients (HOG), histogram of optical flows (HOF), and convolutional neural network (CNN) to the main processor, in order to extract the motion information. The cloud may analyze the video and the motion information and send a result of the analysis to the processor.

The intelligent security device may transmit, to a 5G network, the motion information transmitted in wireless communication. The wireless communication may be implemented using a Bluetooth personal area network. The wireless communication may also be implemented using Wi-Fi local area network, or using combinations of different wireless network technologies.

The cloud may determine motion information based on at least one of the video and the motion information and generate field status information based on this. The cloud may send or provide the field status information to the transceiver. The cloud may convert the field status information into a command, which can be executed by the processor, and send the command to the transceiver in S730.

The command may include a first command capable of determining whether there is the potential crime based on the video and the motion information and a second command capable of determining whether there is the potential user based on the video and the motion information.

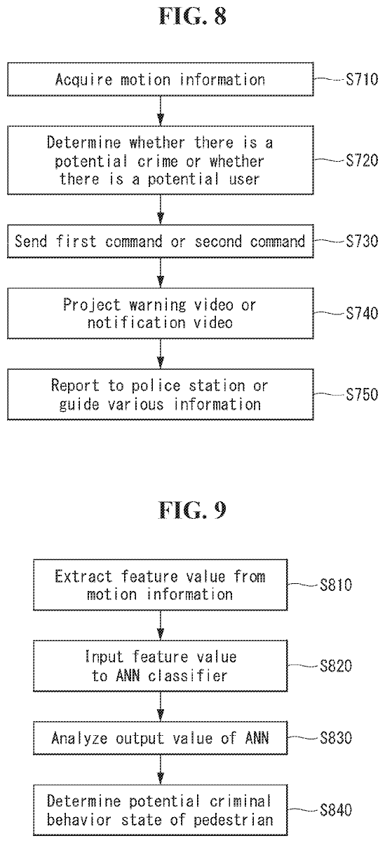

A detailed process for determining the field status information is described later with reference to FIG. 9. As described above, the determination of the field status information based on the video and the motion information may be performed by the 5G network or the intelligent security device itself.

If the first command is sent, the step may project a warning video or output a warning sound in a corresponding area with a high probability of the occurrence of the potential crime in S740. The warning video may be projected or displayed on the corresponding area through a projector. The warning video may be a video which enables pedestrians located in or around the corresponding area or people around the pedestrians to recognize surroundings or a field status, etc. The warning sound may be output to the corresponding area through an audio processing and transmission unit.

If the second command is sent, the step may project a notification video or output a notification sound in a corresponding area in which the potential user exists in S740. The notification video may be projected or displayed on the corresponding area through a projector. The notification sound may be output to the corresponding area through the audio processing and transmission unit. The notification video may be a video that enables a variety of information to be guided to the potential user. The notification sound may guide a variety of information to the potential user through sound.

After the warning video or the notification video is projected on the corresponding area, the processor may control the camera and continue to capture the corresponding area. The processor may continue to monitor the corresponding area and send a video and motion information of the corresponding area to the cloud.

If the pedestrian is continuously in a potential crime state even after the warning video is projected or the warning sound is output, the cloud may decide to report to the police station in S750. Alternatively, the cloud may guide a variety of information to the potential user in S750. Further, the cloud may send information (or signal) related to remote control to the intelligent security device.

FIG. 9 illustrates an example of determining a potential criminal state if a first command is sent in accordance with an embodiment of the present disclosure.

Referring to FIG. 9, the processor may extract feature values from motion information acquired by at least one camera to determine field status information in S810.

For example, the processor may receive motion information from at least one camera. The processor may extract a feature value from the motion information. The feature value is determined to indicate in detail a transition from an ordinary everyday behavior to a potential criminal behavior among at least one feature capable of being extracted from the motion information.

The processor may be configured to input the feature values to an artificial neural network (ANN) classifier that is trained to distinguish between the ordinary everyday behavior and the potential criminal behavior in the corresponding area in S820.

The processor may combine the extracted feature values and to generate a crime detection input. The crime detection input may be input to the ANN classifier that is trained to distinguish whether the pedestrian is in a normal state or an abnormal state based on the extracted feature values.

The processor may analyze an output value of an artificial neural network (ANN) in S830 and determine a potential criminal behavior state of the pedestrian based on the output value of the ANN in S840.

The processor may identify whether a crime is likely to occur in the corresponding area or whether a crime has occurred in the corresponding area based on an output of the ANN classifier.

FIG. 9 illustrates an example where an operation of the pedestrian identifying a criminal state through AI processing is implemented in the processing of the intelligent security device, but the present disclosure is limited thereto. For example, an operation identifying the criminal state of the pedestrian through the AI processing may be implemented over the 5G network based on motion information received from the intelligent security device.

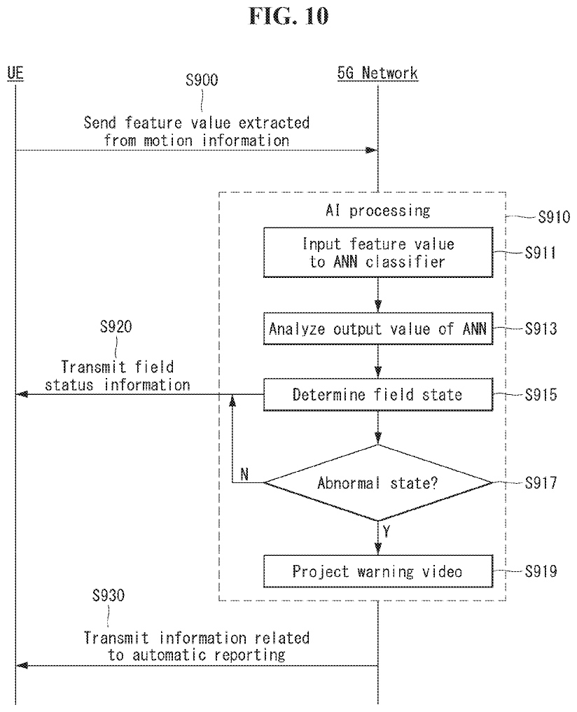

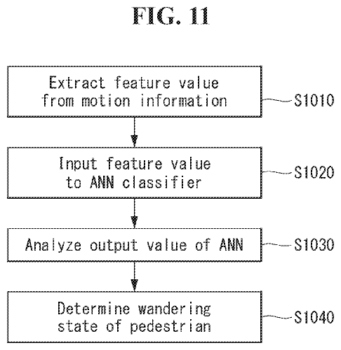

FIG. 10 illustrates another example of determining a potential criminal state if a first command is sent in accordance with an embodiment of the present disclosure.

The processor may control a transceiver to transmit motion information to an AI processor included in the 5G network. Further, the processor may control the transceiver to receive AI-processed information from the AI processor. The AI processor may be called a cloud processor.

The AI-processed information may be information determined as one of a normal state and an abnormal state of a pedestrian. The abnormal state may include a potential criminal behavior state or a criminal behavior state.

The intelligent security device may perform an initial access procedure with the 5G network to transmit the motion information to the 5G network. The intelligent security device may perform the initial access procedure with the 5G network based on a synchronization signal block (SSB).

The intelligent security device may receive, from the network, downlink control information (DCI) that is used to schedule transmission of motion information of a pedestrian acquired by at least one camera included inside the intelligent security device through the transceiver.

The processor may transmit, to the network, the motion information of the pedestrian based on the DCI.

The motion information of the pedestrian is transmitted to the 5G network via PUSCH, and the SSB and a DM-RS of the PUSCH may be QCLed for QCL type D.

Referring to FIG. 10, an intelligent security device may send a feature value extracted from motion information to a 5G network in S900.

Here, the 5G network may include an AI processor or an AI system. The AI system of the 5G network may perform AI processing based on the received motion information in S910.

The AI system may input feature values received from the intelligent security device to an ANN classifier in S911. The AI system may analyze an ANN output value in S913 and determine a field status of a corresponding area based on the ANN output value in S915. The 5G network may transmit field status information of the pedestrian determined by the AI system to the intelligent security device through the transceiver in S920.

The field status information of the pedestrian may include whether a behavior of the pedestrian is normal or abnormal, a state starting to transition from a normal behavior to an abnormal behavior, and the like.

If the AI system determines the behavior of the pedestrian as an abnormal state in S917, the AI system may be configured to project a warning video on a corresponding area or send a warning sound to the corresponding area in S919.

If the pedestrian is continuously in the abnormal state even after the warning video is projected or the warning sound is sent, the AI system may decide to report to the police station in S930.

The intelligent security device may transmit only the motion information to the 5G network and extract a feature value corresponding to a crime detection input, that is used as an input of the artificial neural network for determining whether the behavior of the pedestrian is in the normal state or the abnormal state, from the motion information within the AI system included in the 5G network.

FIG. 11 illustrates an example of determining whether there is a potential user if a second command is sent in accordance with an embodiment of the present disclosure.

Referring to FIG. 11, the processor may extract feature values from motion information acquired by at least one camera to determine field status information in S1010.

For example, the processor may receive motion information from at least one camera. The processor may extract a feature value from the motion information. The feature value is determined to indicate in detail a transition from an ordinary everyday behavior to a wandering behavior among at least one feature capable of being extracted from the motion information.

The processor may be configured to input the feature values to an ANN classifier that is trained to distinguish between the ordinary everyday behavior and the wandering behavior in the corresponding area in S1020.

The processor may combine the extracted feature values to generate a guide detection input. The guide detection input may be input to the ANN classifier that is trained to distinguish whether the pedestrian is in a wandering state based on the extracted feature value.

The processor may analyze an output value of an ANN in S1030 and determine a wandering state of the pedestrian based on the output value of the ANN in S1040.

The processor may identify whether a potential user of the wandering state exists in the corresponding area based on an output of the ANN classifier.

FIG. 11 illustrates an example where an operation of the pedestrian identifying the wandering state through AI processing is implemented in the processing of the intelligent security device, but the present disclosure is limited thereto. For example, an operation identifying the wandering state of the pedestrian through the AI processing may be implemented over the 5G network based on motion information received from the intelligent security device.

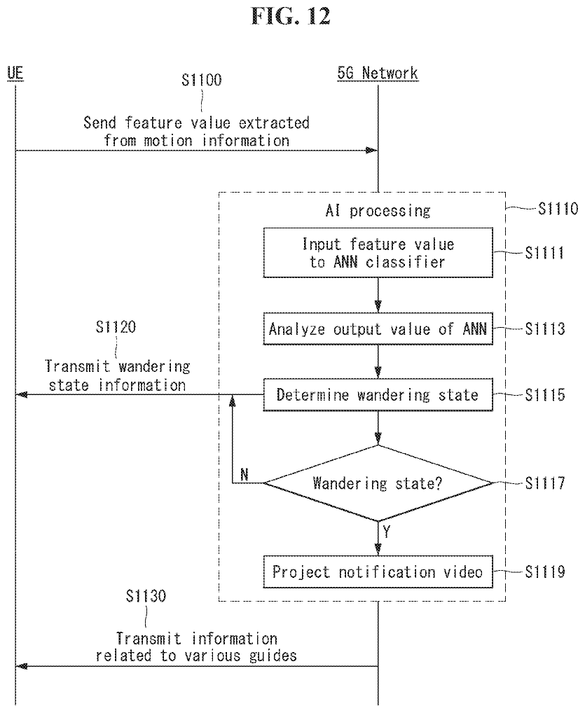

FIG. 12 illustrates another example of determining whether there is a potential user if a second command is sent in accordance with an embodiment of the present disclosure.

The processor may control a transceiver to transmit motion information to an AI processor included in the 5G network. Further, the processor may control the transceiver to receive AI-processed information from the AI processor. The AI processor may be called a cloud processor.

The AI-processed information may be information determining a wandering state of a pedestrian.

The intelligent security device may perform an initial access procedure with the 5G network to transmit the motion information to the 5G network. The intelligent security device may perform the initial access procedure with the 5G network based on a synchronization signal block (SSB).

The intelligent security device may receive, from the network, downlink control information (DCI) that is used to schedule transmission of motion information of a pedestrian acquired by at least one camera included inside the intelligent security device through the transceiver.

The processor may transmit, to the network, the motion information of the pedestrian based on the DCI.

The motion information of the pedestrian is transmitted to the 5G network via PUSCH, and the SSB and a DM-RS of the PUSCH may be QCLed for QCL type D.

Referring to FIG. 12, an intelligent security device may send a feature value extracted from motion information to a 5G network in S1100.

Here, the 5G network may include an AI processor or an AI system. The AI system of the 5G network may perform AI processing based on the received motion information in S1110.

The AI system may input feature values received from the intelligent security device to an ANN classifier in S1111. The AI system may analyze an ANN output value in S1113 and determine a wandering state of a corresponding area based on the ANN output value in S1115. The 5G network may transmit wandering state information of the pedestrian determined by the AI system to the intelligent security device through the transceiver in S1120.

The wandering state information of the pedestrian may include whether a direction of the pedestrian is uniform, whether a walking speed of the pedestrian is uniform, and the like.

If the AI system determines the pedestrian as the wandering state in S1117, the AI system may be configured to project a notification video on a corresponding area or send a notification sound to the corresponding area in S1119.

The AI system may project a notification video or send a notification sound and induce a potential user or a pedestrian to a location to which he/she intends to be guided.

Afterwards, if a potential user or a pedestrian is located in a predetermined guide area, the AI system may extract a feature value for their state. That is, the AI system may analyze the extracted feature value, determine a state of the potential user or the pedestrian, and guide them through a method suitable for them S1130.

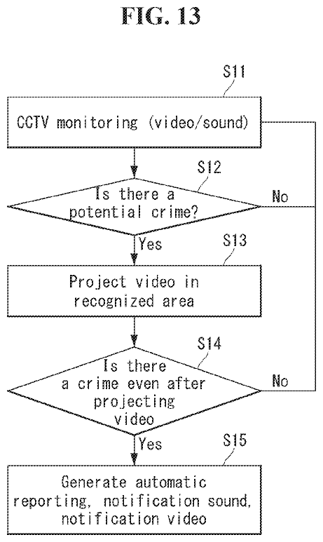

FIG. 13 illustrates an example of determining a potential criminal state using an intelligent security device according to an embodiment of the present disclosure.

The processor may maintain a constant monitoring state using a camera in S11. The processor may transmit a video input by the camera to a cloud through wireless communication such as a 5G Network. The cloud may learn in real time the transmitted video.

The cloud may analyze and learn the transmitted video through an artificial neural network or an artificial intelligence model and determine whether there is a potential crime in S12. For example, the cloud may determine whether there is a potential crime in a processing area of a vision through the learned artificial intelligence model of the cloud. If the cloud determines that there is no potential crime, the cloud may continuously perform the monitoring through the camera.

If the cloud determines that there is a potential crime, the cloud may rotate the camera toward a potential crime scene through vision recognition. The cloud may project a warning video on a corresponding area and allow people around the corresponding area to recognize this situation in S13.

The cloud may analyze the behavior and the voice of people in the corresponding area through the camera and a microphone after projecting the warning video and determine whether a criminal behavior continues in S14.

If the crime is determined as a result of learning, the cloud may automatically report to the police station, send a notification sound to the corresponding area, and generate a notification video in the corresponding area to warn of the crime in S15. The processor may control the camera to monitor the processing area of the vision and to continuously transmit in real time the monitored video to the cloud.

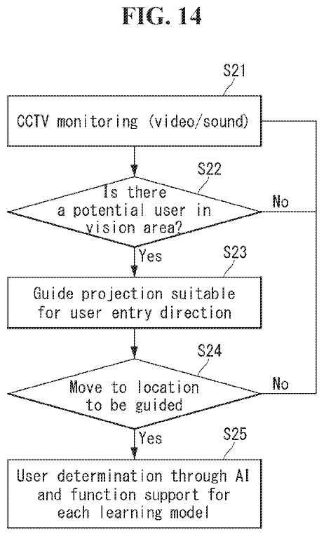

FIG. 14 illustrates an example of determining a potential user using an intelligent security device according to an embodiment of the present disclosure.

The processor may maintain a constant monitoring state using a camera in S21. The processor may transmit a video input by the camera to a cloud through wireless communication such as a 5G Network. The cloud may learn in real time the transmitted video.

The cloud may analyze and learn the transmitted video through an artificial neural network or an artificial intelligence model and determine whether there is a potential user in S22. For example, the cloud may determine whether there is a potential user in a processing area of a vision through the learned artificial intelligence model of the cloud. If the cloud determines that there is no potential user, the cloud may continuously perform the monitoring through the camera.

If the cloud determines that there is a potential user, the cloud may recognize a direction in which the potential user enters the processing area of the vision in the transmitted video S23. That is, the cloud may express an image or a writing, which is to be guided according to user's eye orientation, by an image projection device.

Afterwards, the cloud may determine the intention of the user by inducing the user to a designated location for receiving a guide function support in S24. That is, the cloud may determine, through the vision, whether the user has moved to an area indicated by a projector.

The cloud may determine a user' state (foreigner, disabled, etc.) and output and process, to a projector or a speaker, a result of processing and determining in a model, that is learned through the voice or the video input in a manner (translation, voice recognition, gesture recognition, etc.) suitable for the user, in S25.

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state drive (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the present disclosure should be determined by the appended claims and their legal equivalents, not by the above description, and all changes coming within the meaning and equivalency range of the appended claims are intended to be embraced therein.

What is claimed is:

1. An intelligent security device comprising:
a camera;
a transceiver configured to communicate with a cloud or an external device; and
a controller configured to:
acquire motion information of a pedestrian based on a video captured by the camera,
transmit, via the transceiver, the motion information or the video to the cloud or the external device,
execute a warning function when a behavior of the pedestrian is determined to correspond to a potential criminal behavior, and
execute a guiding function when the behavior of the pedestrian is determined to correspond to a wandering behavior.

2. The intelligent security device of claim 1, wherein the controller is further configured to:
receive, from the cloud or the external device, field status information indicating whether the behavior is determined as corresponding to the potential criminal behavior or the wandering behavior,
wherein the field status information is generated by the cloud or the external device based on the motion information.

3. The intelligent security device of claim 1, wherein the controller is further configured to:
extract features values from the motion information acquired by the camera,
input the features values to an artificial neural network (ANN) classifier trained to distinguish whether the pedestrian is in an everyday behavior state corresponding to a normal state or a criminal behavior state corresponding to an abnormal state, and
determine whether the pedestrian in is the normal state or the abnormal state based on an output of the ANN classifier.

4. The intelligent security device of claim 3, wherein the ANN classifier is included in the intelligent security device.

5. The intelligent security device of claim 3, wherein the ANN classifier is included in the cloud or the external device.

6. The intelligent security device of claim 1, wherein the controller is further configured to:
extract features values from the motion information acquired by the camera,
input the features values to an artificial neural network (ANN) classifier trained to distinguish whether the pedestrian is in an everyday behavior state or a wandering state, and
in response to determining that the pedestrian is in the wandering state based on an output of the ANN classifier, execute the guiding function.

7. The intelligent security device of claim 6, wherein the ANN classifier is included in the intelligent security device.

8. The intelligent security device of claim 6, wherein the ANN classifier is included in the cloud or the external device.

9. The intelligent security device of claim 1, wherein the motion information includes at least one of a behavior of the pedestrian, a walking speed of the pedestrian, a walking path of the pedestrian, or a walking style or pattern of the pedestrian.

10. The intelligent security device of claim 1, further comprising:
a projector configured to output video or information on an area around the intelligent security device,
wherein the warning function includes projecting a warning video or warning information on at least part of the area corresponding to the pedestrian.

11. The intelligent security device of claim 1, further comprising:
a projector configured to output video or information on an area around the intelligent security device,
wherein the guiding function includes projecting a guiding video or guiding information on at least part of the area corresponding to the pedestrian.

12. The intelligent security device of claim 1, wherein the controller is further configured to:
receive, from a network, downlink control information (DCI) for scheduling transmission of the motion information acquired by the camera, and
wherein the motion information is transmitted to the network based on the DCI.

13. The intelligent security device of claim 12, wherein the controller is further configured to perform an initial access procedure with the network based on a synchronization signal block (SSB),
wherein the motion information is transmitted to the network via a physical uplink shared channel (PUSCH), and
wherein the SSB and a DM-RS of the PUSCH are QCLed for QCL type D.

14. The intelligent security device of claim 12, wherein the controller is further configured to:
control the transceiver to transmit the motion information to an artificial intelligence (AI) processor included in the network, and
control the transceiver to receive AI-processed information from the AI processor,
wherein the AI-processed information including information indicating whether the behavior of the pedestrian is one of a normal state or an abnormal state.

15. The intelligent security device of claim 1, wherein the controller is configured to:
transmit a reporting message to a police or a designated authority when the behavior of the pedestrian is determined to correspond to the potential criminal behavior.

16. A method for controlling an intelligent security device, the method comprising:
receiving a video of a pedestrian captured by a camera included in the intelligent security device;
acquiring motion information of the pedestrian based on the video;
transmitting, via a transceiver in the intelligent security device, the motion information or the video to a cloud or an external device;
executing a warning function when a behavior of the pedestrian is determined to correspond to a potential criminal behavior; and
executing a guiding function when the behavior of the pedestrian is determined to correspond to a wandering behavior.

17. The method of claim 16, further comprising:
receiving, from the cloud or the external device, field status information indicating whether the behavior is determined as corresponding to the potential criminal behavior or the wandering behavior,
wherein the field status information is generated by the cloud or the external device based on the motion information.

18. The method of claim 16, further comprising:
extracting features values from the motion information acquired by the camera;
inputting the features values to an artificial neural network (ANN) classifier trained to distinguish whether the pedestrian is in an everyday behavior state corresponding to a normal state or a criminal behavior state corresponding to an abnormal state; and
determining whether the pedestrian in is the normal state or the abnormal state based on an output of the ANN classifier.

19. The method of claim 18, wherein the ANN classifier is included in the intelligent security device, the cloud or the external device.

20. The method of claim 16, wherein the warning function includes projecting, via a projector in the intelligent security device, a warning video or warning information on at least part of an area around the intelligent security device, and
wherein the guiding function includes projecting, via the projector, a guiding video or guiding information on the at least part of the area around the intelligent security device.
